(19) United States
(12) Patent Application Publication
(10) Pub. No.: US 2014/0262735 A1
(43) Pub. Date: Sep. 18, 2014

(54) SYSTEM AND METHOD FOR TREATING CONTAMINATED WATER

(71) Applicant: Wasserwerk, Inc., Columbia, MO (US)

(72) Inventor: Wayne R. Hawks, Columbia, MO (US)

(73) Assignee: Wasserwerk, Inc., Columbia, MO (US)

(21) Appl. No.: 14/208,005

(22) Filed: Mar. 13, 2014

Related U.S. Application Data
(60) Provisional application No. 61/779,668, filed on Mar. 13, 2013.

(51) Int. Cl. C02F 9/00; B01D 3/32; C02F 1/04; C02F 1/28

(52) U.S. Cl. CPC C02F 9/00; C02F 1/281; B01D 3/32; C02F 1/04
USPC 203/10; 210/243; 210/201; 210/241; 210/681; 210/685; 210/287; 210/435; 202/159; 210/85; 210/180

(57) ABSTRACT

A water treatment system including a filter, an aerator, a hydrogen absorption manifold, a first treatment container, a second treatment container, a boiler, a superheater, a fractional distillation separator and a condenser. The filter is adapted for removing chloride ions and transmutated chlorine ions; while the hydrogen absorptive manifold is designed for absorbing hydrogen ions and reducing the pH of the water. The boiler and superheater may be utilized to convert the water to a superheated steam, while the fractional distillation separator is adapted for condensing and separating elements, including radioactive elements, from the superheated steam. A method for treating contaminated water using the water treatment system is also provided.

### CROSS-REFERENCE TO RELATED APPLICATIONS

This Application claims priority to U.S. Provisional Patent Application Ser. No. 61/779,668, filed on Mar. 13, 2013, to Wayne R. Hawks entitled “System and Method for Treating Fracturing Water,” currently pending, the entire disclosure of which is incorporated herein by reference.

### BACKGROUND OF THE INVENTION

Hydraulic fracturing (or “Tracking”) is a well-known process utilized by the oil and gas industry to create and enlarge fractures in underground shale formations. The fractures allow oil and natural gas to move more freely through the shale formations and ultimately flow to the surface. In the fracking process, explosions are set off to create the fractures and then high-pressure fluid is injected into the well in order to perpetuate the fracturing and hold the fractures open.

The fracturing fluid is typically comprised of water containing a proppant and chemical solution mixed therein. The fracturing fluid is often composed of between about 98-99.5% water and sand with the additional chemical solution accounting for about 0.5-2%. The water includes, in significant part, freshwater that must be transported to the well site by tanker truck or piping. The proppant, which is often sand or a similar material, is used to keep the fractures from closing after the injection has stopped. The chemical solution includes a variety of additives having dosage rates that vary with the location and condition of the specific well. These additives may include, but are not limited to, acids (e.g., hydrochloric acid), corrosion inhibitors (e.g., alcohols, organic acids, polymers, sodium salt, glycol and amide), iron control chemicals (e.g., sodium compounds and citric acid), antibacterial agents, biocides (e.g., gluteraldhyde, alcohols, sodium salt, sodium hydroxide and bromide salt), scale inhibitors (e.g., alcohols, organic acids, polymers, sodium salt, glycol and amide), friction reducers (e.g., polymers, hydrocarbons and water soluble polymers), surfactants (e.g., alcohols, glycols and hydrocarbons), gelling agents (e.g., guar gum, hydrocarbons and polymers), breakers (e.g., ammonium persulfate, sodium and potassium salts) and crosslinkers (e.g., polyol and borax).

The fracking process typically requires between about one million and five million gallons of water or more per well. A portion of the water that is injected into the well returns to the surface as “flowback water.” While the flowback water returns to the surface over a period of three to four weeks, most of the flowback water returns within the first seven to ten days. The volume of recovery is generally between about 20-60% of the volume that was initially injected into the well. The rest of the fluid is absorbed in the shale formation. At a certain point, there is a transition from primarily recovering flowback water to primarily recovering “produced water,” which is water naturally occurring in the shale formation that flows to the surface over the life of the well.

Upon returning to the surface and exiting the well, the flowback water and produced water is generally collected in tanks, open pools or lagoons located near the well. From there, the flowback water and produced water is pumped into tanker trucks and transported from the well site to a deep disposal well where the water is placed back into the ground. Each disposal well typically costs several million dollars to drill and maintain. Disposal wells can additionally create environmental and water source contamination concerns.

The flowback water and produced water is typically contaminated with man-made and naturally-occurring substances. The water is contaminated with the spent chemicals that are mixed into the fracking water prior to its injection into the well, as discussed above. The water is also contaminated with naturally-occurring substances residing below the Earth's surface. For example, the water may have elevated levels of Kjeldahl nitrogen, petroleum residue, sodium, ammonia, chloride, sulfate, chloride sulfate, total dissolved solids (TDS), chloride, barium, strontium, boron, benzene, ethylbenzene, toluene, xylene, glycols, 2-butoxyethanol, radionuclides such as radium isotopes (e.g., radium-226 and radium-228), uranium-238 and lead-210 and other naturally occurring radioactive material (“NORM”) found in the shale formations. Additionally, some scientists believe that the explosions occurring during the fracturing of the shale formation set off chain reactions that result in the creation of radioactive material in addition to the NORM already present in the shale formations.

In order for the flowback water and the produced water to be reused as fracturing water or discharged to the environment, it must first be treated. As such, a need exists for a system and method for treating contaminated flowback water and produced water such that it can be reused and the cost and environmental concerns resulting from the disposal wells can be eliminated. A particular need exists for a system and method for removing radioactive materials from flowback water and produced water. A further need exists for a system that is self-contained and is mobile between well sites and may be scaled up or down depending upon the amount and quality of the water to be treated.

### BACKGROUND OF THE INVENTION

One embodiment of the present invention is directed to a water treatment system that includes a filter, an aerator, a hydrogen absorption manifold, a first treatment container, a second treatment container, a boiler, a superheater, a fractional distillation separator and a condenser.

The filter can be in the form of a filter compartment having a material therein suitable for removing chloride ions and transmutated chlorine ions from water passing through said system. The material contained in the compartment may include at least one of coconut carbon, ionized sand and cadmium. The aerator is suitable for oxygenating the water and may be located at an exit end of the filter compartment. The hydrogen absorptive manifold is designed for absorbing hydrogen ions and reducing the pH of the water. The absorptive manifold may be constructed of an outer tube surrounding an inner plate having a plurality of fins extending therefrom. The fins can be constructed from gold, silver, palladium, nickel, zinc, tin, indium and/or copper. The absorptive manifold may also include an electromagnet for controlling electromagnetic radiation.

The first treatment container, which may be in the form of a concrete containment basin, is in fluid communication with the absorptive manifold. The first container may include a voltage accelerator, such as a P dope N dope voltage accelerator, for inducing a charge in said water. The voltage accelerator may include a positively charged plate and a negatively charged plate submerged in the water within the first container. The first container may also include first pollutant collection substrate contained in a hanging bag which may include silicon dioxide, calcium carbonate and/or cadmium. An oil snout may further be included in the first container for capturing oil and benzene molecules from the water. The second treatment container, which may also be in the form of a concrete containment basin, is in fluid communication with the first container and may include a screen therein that includes at least one of nickel and calcium carbonate.

In one embodiment, the system includes a heater comprised of a boiler and a superheater. The boiler may be adapted for converting the water into a saturated steam, while the superheater can be designed to convert the saturated steam to a superheated steam. The superheated steam may be directed to a fractional distillation separator configured for condensing elements, including radioactive elements, by atomic mass units. The fractional distillation separator includes a plurality of internal plates, each having an aperture defined therethrough. Extending upwardly from each aperture may be a pipe that is topped with a dome-shaped cap configured for condensing elements by atomic mass units. The condensed elements may flow from the fractional distillation separator via apertures defined in an outer shell adjacent the caps. The system may further include a condenser in fluid communication with an outlet of the fractional distillation separator for condensing the steam flowing from the fractional distillation separator.

Another aspect of the present invention is directed to a method for treating contaminated water including the steps of: collecting contaminated water, filtering the water to remove hydrogen ions, directing the water through an absorptive manifold to absorb hydrogen ions and inducing a charge in the water with a voltage accelerator. The method may also include the steps of: boiling the water to create saturated steam, heating the saturated steam to convert the saturated steam to a superheated steam, introducing the superheated steam to a fractional distillation separator, separating contaminants from the superheated steam in the fractional distillation separator and condensing the steam upon discharge from the fractional distillation separator.

Other aspects and advantages of the present invention will be apparent from the following detailed description of the preferred embodiments and the accompanying drawing figures.

### DESCRIPTION OF THE SEVERAL VIEWS OF THE DRAWINGS

In the accompanying drawings, which form a part of the specification and are to be read in conjunction therewith in which like reference numerals are used to indicate like or similar parts in the various views:

FIG. 1 is a schematic side view of a system for treating contaminated water in accordance with one embodiment of the present invention;

FIG. 2 is a schematic top view of a system for treating contaminated water in accordance with one embodiment of the present invention;

FIG. 3A is a sectional side view of an absorptive manifold for reducing the pH of water in accordance with one embodiment of the present invention;

FIG. 3B is a sectional end view of an absorptive manifold for reducing the pH of water in accordance with one embodiment of the present invention;

FIG. 4 is a schematic view of a superheater component for a system for treating contaminated water in accordance with one embodiment of the present invention;

FIG. 5 is a schematic view of a fractional distillation column for a system for treating contaminated water in accordance with one embodiment of the present invention;

FIG. 6A is a sectional side view of a condensing unit in accordance with one embodiment of the present invention;

FIG. 6B is a sectional end view of a condensing unit in accordance with one embodiment of the present invention;

FIG. 7 is an overhead schematic layout of a multiple drilling site operation including a central water treatment plant in accordance with one embodiment of the present invention; and

FIG. 8 is an overhead schematic layout of a multiple drilling site operation including a central water treatment plant in accordance with another embodiment of the present invention.

### DETAILED DESCRIPTION OF THE INVENTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

The following detailed description of the invention references specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The present invention is defined by the appended claims and the description is, therefore, not to be taken in a limiting sense and shall not limit the scope of equivalents to which such claims are entitled.

The entire disclosures of pending U.S. patent application Ser. No. 13/627,765, filed on Sep. 26, 2012 to Wayne R. Hawks entitled “Self-Container Irrigation Treatment System” and U.S. Application Ser. No. 13/219,080, filed on Aug. 26, 2011 to Wayne R. Hawks entitled “Self-Container Irrigation Treatment System” are incorporated herein by reference. The terms “contaminated water” and “water,” when used independently of any adjectives herein, shall refer to either one or all of fracking water, flowback water, produced water or other contaminated water treated by the system of the present invention.

FIGS. 1 and 2 generally illustrate one embodiment of the system 10 of the present invention, which may optionally be contained within one or more mobile semi-trailers 12. Alternatively, the system 10 may be stationary or may be transportable through various other modes, including but not limited to, trucks, trains, planes, boats and barges.

As illustrated, the system 10 is normally located adjacent a source of contaminated water 14, which may come directly from a well or may be contained within one or more tanks, barrels, open pools, lagoons or ponds near the well. The source of water 14 may include fracking water, flowback water, produced water, water used in coal production and dust control, water used in coal-fired power plants, water used in nuclear power plants, water from contaminated reservoirs, ponds, rivers and streams or any other source of contaminated water. A pump 16 may be provided to transport the contaminated water into the system 10.

The system 10 may include a filter 18 comprising a canister or compartment 20 that contains coconut carbon (i.e., activated carbon made from coconut shells), ionized sand and cadmium (Cd) for removing chloride and transmutated chlorine ions (Cl⁻) and absorbing neutrons. The cadmium (Cd) acts as a neutron absorber and the sand, which is silicon dioxide (SiO₂), ties up the chlorine ions. An aerator 22 may be placed at the exit end 24 of the filter compartment 20 in order to oxygenate the water as it flows from the filter 18.

A hydrogen absorptive manifold 26 for absorbing hydrogen ions and reducing the pH of the water may be provided in fluid communication with the filter compartment 20. The manifold 26, which is illustrated in more detail in FIGS. 3A and 3B, may be constructed of an outer tube 28 surrounding an inner plate 30 having a plurality of fins 32 extending therefrom. In one embodiment, for example in a batch-scale, pilot embodiment, the outer tube 28 is a 4-inch Type M copper pipe and includes an electromagnet 34 attached to the inside of a 3-inch one half pipe at the highest pollution level water line to assist in controlling electromagnetic radiation. In this embodiment, the plate 30 can be a 3-inch diameter Type M copper pipe of generally equivalent length cut in half, as illustrated in FIG. 3A. Fins 32 may be constructed of various materials, for example, gold (Au), silver (Ag), palladium (Pd), nickel (Ni), zinc (Zn), tin (Sn), indium (In) and copper (Cu). The fins 32 can extend from the plate 30 and act as hydrogen ion (H+) absorbers to reduce the pH in the contaminated water. In one embodiment, the pH of the water may be reduced to approximately 6.4.

The system 10 can include a first container 36, such as a concrete containment basin (CCB) or other suitable barrel or tank, that has a P dope N dope voltage accelerator or regulator 38. The first container 36 is in fluid communication with the absorptive manifold 26. As shown in FIGS. 1 and 2, the voltage accelerator 38 may comprise a positively-charged cathode 40 connected to a positively-charged plate 42 and a negatively-charged anode 44 connected to a negatively-charged plate 46. The plates 42 and 46 are submerged in the water located in the first container 36 to induce a low voltage DC current through the water. The charge may be either 6V or 12V and have an amperage of 2, 10, 40 or 200 amperes, for example. By creating a charge on the dielectric constant, electrons are moved from one level to another in order to alter the atomic structure of each element and alter electron interaction.

In one embodiment, the first container 36 also includes a filter 48 which may be in the form of a hanging bag containing pollutant collection substrates such as silicon dioxide (SiO₂), calcium carbonate (CaCO₃) and cadmium (Cd) to absorb chloride ions (Cl⁻) and neutrons, including neutrons of barium (Ba). The container 36 can also comprise an oil snout 50 in connection with its discharge orifice or port 52, as shown in FIG. 1. As water passes through the oil snout 50, the oil snout 50 separates and captures oil and benzene (C₆H₆) molecules from the water. The oil and benzene collected by the oil snout 50 may be diverted to a container or barrel (not shown) and stored for later transportation, disposal or reuse.

A second container 54, such as a CCB or other suitable barrel or tank, may be provided downstream of and in fluid communication with the first container 36. The second container 54 can include a stainless steel screen filter 56 through which the water passes for absorption separation. The screen filter 56 may further comprise a variety of elements and compounds, such as nickel (Ni) and calcium carbonate (CaCO₃).

From the second container 54, the water may be pumped by an electric pump 13 into a return tank 60, which is discussed in more detail below and then into a superheater system that can include a boiler 62 and a superheater 64. The boiler 62 boils the water to create steam, which then flows into the steam superheater 64. Once in the superheater 64, the saturated steam from the boiler 62 is heated to a temperature of between about 600° F. and 1,200° F. to prepare it for fractional separation. In one embodiment, the saturated steam is heated to a temperature of approximately 900° F.

As illustrated in FIG. 4, the superheater 64 comprises an inner pipe 66 inside of an outer pipe 68, both of which may be constructed of stainless steel. The inner pipe 66 can include a plurality of circular gaskets 70 for flame dissipation of heat. A source of heat 72 can be inserted into a holder 74 attached proximate an upstream end of the outer pipe 68. Advantageously, a temperature differential in the steam between the entrance 76 of the superheater 64 and its exit 78 is created. To measure this temperature differential, thermometers 80 and 82 may be positioned at each end 76 and 78 of the superheater 64 and optionally at locations therebetween. In order to further distribute heat evenly throughout the length of the superheater 64, a vacuum fan 84 may be connected proximate a downstream end of the superheater 64 as well.

From the superheater 64, the superheated steam, which may be approximately 900° F., passes into a fractional distillation separator or column 86 through an inlet aperture 88 proximate a lower end of an outer shell 90. The fractional distillation column 86 is schematically illustrated in FIG. 5. The column 86 includes a plurality of internal plates or trays 92 having apertures 94 defined therethrough. Extending upwardly from each aperture 94 may be a pipe 96. A dome-shaped cap 98 may be welded or otherwise attached to a top end of each pipe 96. The caps 98 are configured for condensing elements by atomic mass units (amu). The condensed elements 100a, 100b, 100c and 100d may include heavy metals and/or radioactive materials, such as radium-226, radium-228, uranium-238 and uranium-235, for example. The condensed contaminants 100a, 100b, 100c and 100d flow out of the column 86 via apertures 102 and are collected in one or more catch containers 104 where they are stored for later removal, transportation and proper disposal. Other contaminates 106 may be discharged from the fractional distillation column 86 through a lower aperture 108. The column outer shell 90, plates 92, pipes 96 and caps 98 may all be constructed of stainless steel or another suitable metallic material.

Purified steam can flow from an outlet aperture 110 proximate an upper end of the fractional distillation column 86 to into a condenser 112 that may include two or more condensing units 114 organized in series or parallel for increased efficiency. Once condensed, the purified water may be collected in a tank 116, which may have three outlets 118, 120 and 122. A first outlet 118 may be connected to a test tank 124 containing one or more living organisms, such as fish, for observation of the effects of the treated water on the living organisms in order to assist in monitoring the effectiveness of the treatment process by allowing observation of the living organisms' behavior and health in the treated water. A second outlet 120 can be connected to a line 126 that delivers the water back to the return tank 60 discussed above if it is determined that additional processing of the water is necessary for increased purification levels. At this point CO₂ or O₂ under low pressure may be injected into the return tank 60 through a control orifice for chemical adjustments of the polluted water. The water may be cycled through the boiler 62, superheater 64 and fractional distillation column 86 as many times as necessary to treat the water. The return tank 60 can include a float system (not shown), for example either Model 21 or Model 221 manufactured by ITT/McDonnell and Miller. Depending upon the flow rate of water entering the return tank 60 from the second container 54 and the flow rate of the water entering the return tank 60 from the return line 126, the float system may prohibit flow from either the second container 54 or return line 126. Typically, if the combined flow rates exceed the system's capacity, flow from the container 54 is prohibited or restricted if necessary. A third outlet 122 is connected to an exterior faucet 128 for connection to a tank truck or directly back to the fracking water supply system for reuse.

It will be appreciated that the system 10 of the present invention can be suitable for treating any water, not just fracking water, flowback water and produced water from hydraulic fracturing operations.

The present invention is also directed to a method of treating contaminated water using the system 10. In the method, the contaminated water is first collected and directed to the system 10. The water may then be filtered to remove chloride and transmutated chlorine ions therefrom. Next, the water may be directed through a hydrogen absorptive manifold 26 to absorb hydrogen ions. After that, the water can be directed through a first treatment container 36, induced with a charge from a voltage accelerator 38, exposed to pollutant collection substrates and passed through an oil snout 50. The water may then be passed through a second treatment container 54 and a screen 56 container therein.

In another aspect of the method, the water may be boiled to convert it to a saturated steam and the saturated steam may then be converted to a superheated steam. The superheated steam may be introduced to a fractional distillation separator 86 where contaminants, such as heavy metals and radioactive elements, may be removed therefrom. Upon exiting the fractional distillation separator 86, the steam may be condensed back to water in a condenser 112 and discharged from the system 10.

Another aspect of the present invention is directed to the configuration of one or more of the systems 10. Multiple systems 10 may be placed in series or parallel. The system 10 is readily scalable by adding similarly equipped trailers 12 to the system 10. When multiple trailers 12 are utilized, some of the system's 10 components may be located on one trailer 12, while other of the system's 10 components may be located on other trailers 12.

As illustrated in FIGS. 7 and 8, one or more of the water treatment systems 10 of the present invention may be centrally located for use by multiple well sites 130 or locations. FIGS. 7 and 8 each depict an area of land 132 that may consist of a plurality of square miles or sections 134. In one embodiment, the area of land 132 includes twenty-four (24) square mile sections 134. Each section 134 can include one or more well sites 130 having a well drilled thereon, as represented by sections 134a, 134b and 134c. In one embodiment, the area of land 132 includes sixty-four (64) well sites 130; however, it will be understood that any number of well sites 130 may be located within the area of land 132.

As demonstrated in FIG. 7, a central water treatment facility or plant 136 may be adapted and scaled for treating the contaminated water (e.g., fracking water, flowback water, produced water, etc.) associated with each of the well sites 130. The central plant 136 comprises one or more of the systems 10 of the present invention and may be set up on a mobile, temporary, semi-permanent or permanent basis, as desired. The water from each well site 130 may be transported to the central plant 136 by any suitable means, including but not limited to, piping, trench, channel, tanker truck or railcar. As illustrated by the well sites 130 placed on section 134a, the water from each of the well sites 130 may be transported to the central plant 136 via pipes 138, 140 and 142. Optionally, one or more satellite centers 144 and 146 are provided where the water may be collected from multiple well sites 130 for further transportation to a central plant 136. In one embodiment, the satellite centers 144 and 146 may suitably equipped for undertaking a portion of the water treatment process prior to the water being further transported to the central plant 136. The pipes 138 transporting the water from the well sites 130 to the satellite centers 144 and 146 may be of one diameter (e.g., 4 inch), while the pipes 140 and 142 transporting the water from satellite centers 144 and 146 to the central plant 136 may of another, larger diameter (e.g., 8 inch). As depicted in FIG. 7, the need for disposal wells 148 can be eliminated, as represented by each disposal well 148 having an “X” placed thereon. In the example shown, twelve (12) disposal wells 148 are eliminated.

Upon the water being treated at the central plant 136, the water may transported back to other well sites 130, for example via the pipes 142, 140 and 138, for use in the fracking process at those other well sites 130. In other words, the treated water may leave the central plant via a pipe 142, arrive at a first satellite center 146, be directed from the first satellite center 146 to a second satellite center 144 via a pipe 140, and then be directed from the second satellite center 144 to a well site 130 that is ready for fracking via a pipe 138. As such, the water may be used at one well site 130, be treated at the central plant 136, and then used again at another well site 130 upon treatment. Alternatively, the treated water may be discharged from the central plant 136 to a stream or other body of water or otherwise transported from the central plant 136 upon treatment.

FIG. 8 illustrates another embodiment wherein the central plant 136 is located at the center of the area of land 132. Initial processing stations 150, which may in the form of a filtering truck for example, may be provided for initial treatment of the water prior to the water being transported to the central plant 136. These initial processing stations 150 may take the place of, or be similar in nature to, the satellite centers 144. Like the embodiment shown in FIG. 7, the embodiment of FIG. 8 may also eliminate the need for disposal wells 148.

From the foregoing, it will be seen that this invention is one well adapted to attain all the ends and objects hereinabove set forth together with other advantages which are obvious and which are inherent to the structure. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting. It will also be appreciated the components of the system need not be in the order shown in the figures and described above. Rather, depending upon the water to be treated, the components may be aligned or arranged in a different order. In some embodiments, some of the components may be bypassed if certain types of treatment are not necessary. In other embodiments, the water may be cycled through one or more of the components multiple times in order to achieve necessary purification levels.

The constructions described above and illustrated in the drawings are presented by way of example only and are not intended to limit the concepts and principles of the present invention. Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A water treatment system comprising:
a filter compartment containing a first material;
an absorptive manifold in fluid communication with said filter compartment for absorption of hydrogen ions from said water; and
a first container in fluid communication with said absorptive manifold, said first container comprising a voltage accelerator for inducing a charge in said water.

2. The water treatment system of claim 1, wherein said first material is suitable for absorbing neutrons from water passing through said system.

3. The water treatment system of claim 2, wherein said first material comprises cadmium.

4. The water treatment system of claim 1, wherein said first material is suitable for removing at least one of chloride ions and transmutated chlorine ions from water passing through said system.

5. The water treatment system of claim 4, wherein said first material comprises silicon dioxide.

6. The water treatment system of claim 1 further comprising an aerator in fluid communication with an exit end of said filter compartment for oxygenating said water.

7. The water treatment system of claim 1, wherein said absorptive manifold is a hydrogen absorptive manifold adapted for reducing the pH of said water.

8. The water treatment system of claim 1, wherein said absorptive manifold comprises at least one of gold, silver, palladium, nickel, zinc, tin, indium and copper.

9. The water treatment system of claim 1, wherein said absorptive manifold comprises fins constructed from at least one of gold, silver, palladium, nickel, zinc, tin, indium and copper.

10. The water treatment system of claim 1, wherein said absorptive manifold comprises a first conduit connected with an electromagnet.

11. The water treatment system of claim 1, wherein said voltage accelerator is a P dope N dope voltage accelerator.

12. The water treatment system of claim 1, wherein said voltage accelerator includes a positively charged plate and a negatively charged plate submerged in said water located in said first container.

13. The water treatment system of claim 1, wherein said first container further comprises a first pollutant collection substrate therein, said first pollutant collection substrate comprising a material selected from the group consisting of silicon dioxide, calcium carbonate and cadmium.

14. The water treatment system of claim 13, wherein said substrate is contained in a bag hanging in said first container.

15. The water treatment system of claim 1, wherein said first container further comprises an oil snout for capturing at least one of oil and benzene molecules from said water.

16. The water treatment system of claim 1 further comprising a second container in fluid communication with said first container, said second container comprising a screen therein comprising at least one of nickel and calcium carbonate.

17. The water treatment system of claim 1 further comprising:
a heater for heating said water to a steam; and
a fractional distillation separator in fluid communication with said heater, said fractional distillation separator including:
an outer shell;
an inlet aperture proximate a lower end of said outer shell for receiving steam from said heater;
a first plate within said outer shell, said first plate having a first orifice defined therethrough;
a first cap above said first orifice for condensing a first radioactive element;
a first aperture in said outer shell adjacent said first cap for removing said first radioactive element from said steam; and
an outlet aperture proximate an upper end of said outer shell for removal of said steam from said outer shell.

18. The water treatment system of claim 1 further comprising a test tank comprising at least one living organism therein for observation of an effect of said water on said living organism.

19. The water treatment system of claim 18, wherein said living organism is a fish.

20. The water treatment system of claim 1, wherein said system is a mobile, self-contained system.

21. A water treatment system for removing radioactive materials from water, said system comprising:
a heater for heating said water to a steam; and
a fractional distillation separator in fluid communication with said heater, said fractional distillation separator including:
an outer shell;
an inlet aperture proximate a lower end of said outer shell for receiving steam from said heater;
a first plate within said outer shell, said first plate having a first orifice defined therethrough;
a first cap above said first orifice for condensing a first radioactive element;
a first aperture in said outer shell adjacent said first cap for removing said first radioactive element from said steam; and
an outlet aperture proximate an upper end of said outer shell for removal of said steam from said outer shell.

22. The water treatment system of claim 21, wherein said heater comprises a superheater for heating a saturated steam to a superheated steam.

23. The water treatment system of claim 21, wherein said superheater is configured to heat said superheated steam to at least 900° F.

24. The water treatment system of claim 21, wherein said fractional distillation separator comprises a first pipe extending between said first orifice and said first cap.

25. The water treatment system of claim 21, wherein said first radioactive element includes at least one of radium-226, radium-228, uranium-238 and uranium-235.

26. The water treatment system of claim 21, wherein said fractional distillation separator further includes:
a second plate within said outer shell, said second plate being located above said first plate and having a second orifice defined therethrough; and
a second cap above said second orifice for condensing a second radioactive element.

27. The water treatment system of claim 26, wherein said fractional distillation separator includes a second aperture in said outer shell adjacent said second cap for removing said second radioactive element from said steam.

28. The water treatment system of claim 21 further comprising a condenser in fluid communication with said outlet aperture of said fractional distillation separator for condensing said steam flowing from said fractional distillation separator.

29. A method for treating water, said method comprising the steps of:
providing a water treatment system including a filter, an absorptive manifold and a first container provided with a voltage accelerator, each of the foregoing in sequential fluid communication;
collecting contaminated water from a source;
filtering said water in said filter;
directing said water through said absorptive manifold to absorb hydrogen ions from said water;
directing said water through said first container; and
inducing a charge in said water in said first container with said voltage accelerator.

30. The method of claim 29, wherein said filter comprises cadmium for absorbing neutrons from water passing through said system.

31. The method of claim 29, wherein said filter comprises silicon dioxide for removing at least one of chloride ions and transmutated chlorine ions from water passing through said system.

32. A method for treating water, said method comprising the steps of:
providing a water treatment system including a boiler, a superheater, a fractional distillation separator and a condenser;
boiling said water in said boiler to create a saturated steam;
heating said saturated steam to convert said saturated steam to a superheated steam;
introducing said superheated steam to said fractional distillation separator;
separating contaminants from said superheated steam in said fractional distillation separator; and
condensing said superheated steam in said condenser.

33. A water treatment system for treating water from multiple locations, said water treatment system comprising:
a water treatment plant adapted for removing radioactive materials from water; and
piping for transporting water from said multiple locations to said water treatment plant.

34. The water treatment system of claim 33 further comprising at least one satellite center for collecting water from multiple well sites and directing said collected water to said water treatment plant.

35. The water treatment system of claim 33, wherein said water treatment plant includes a filter compartment containing a first material.

36. The water treatment system of claim 35, wherein said first material is suitable for absorbing neutrons from water passing through said system.

37. The water treatment system of claim 36, wherein said first material comprises cadmium.

38. The water treatment system of claim 35, wherein said first material is suitable for removing at least one of chloride ions and transmutated chlorine ions from water passing through said system.

39. The water treatment system of claim 38, wherein said first material comprises silicon dioxide.

40. The water treatment system of claim 33, wherein said water treatment plant includes an absorptive manifold for absorption of hydrogen ions from water passing through said system.

41. The water treatment system of claim 40, wherein said absorptive manifold comprises at least one of gold, silver, palladium, nickel, zinc, tin, indium and copper.

42. The water treatment system of claim 33, wherein said a water treatment plant includes:
a heater for heating said water to a steam; and
a fractional distillation separator in fluid communication with said heater, said fractional distillation separator including:
an outer shell;
an inlet aperture proximate a lower end of said outer shell for receiving steam from said heater;
a first plate within said outer shell, said first plate having a first orifice defined therethrough;
a first cap above said first orifice for condensing a first radioactive element;
a first aperture in said outer shell adjacent said first cap for removing said first radioactive element from said steam; and
an outlet aperture proximate an upper end of said outer shell for removal of said steam from said outer shell.
